(19) United States
(12) Patent Application Publication
(10) Pub. No.: US 2001/0037492 A1
(43) Pub. Date: Nov. 1, 2001

(54) Method and apparatus for automatically extracting verification models

(76) Inventor: Gerard J. Holzmann, Watchung, NJ (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 09/809,499

(22) Filed: Mar. 15, 2001

Related U.S. Application Data
(60) Provisional application No. 60/189,813, filed on Mar. 16, 2000.
(60) Provisional application No. 60/202,664, filed on May 8, 2000.

(51) Int. Cl. G06F 11/00

(52) U.S. Cl. 717/4

(57) ABSTRACT

A verification system for verifying that a software system satisfies a property by extracting a verification model from implementation level source code. The extraction proceeds by translating source strings generated from the code subject to an externally-defined abstraction filter (a so-called conversion table). Standard logic model checking is performed on the extracted verification model to check that the system satisfies (or can possibly violate) any given explicit or implicit logic system property.

### CROSS-REFERENCE TO RELATED APPLICATIONS

This application is related to, and claims priority from, U.S. Provisional application Ser. No. 60/189,813, entitled “Method and Apparatus for Automatically Extracting Verification Models,” filed on Mar. 16, 2000, which is incorporated herein by reference.

### BACKGROUND

The function of a computer system is determined by the software that it executes. The software determines both the usefulness and the vulnerability of the system. Software programs can have defects that can cause loss of functionality with generally unforeseeable consequences. Much effort in the computer industry is therefore devoted to the development of reliable test methods for computer software, that can reveal the presence of defects before a software product is deployed for real-world applications. Where at one time most software applications were designed to execute purely sequentially without significant interactions with other software applications, today most software applications of interest are of a different nature. Today's software applications typically define collections of concurrently executing processes (asynchronous flows of control) that exhibit significant interaction, both internally (within the collection of processes defined) and externally (with externally defined systems of processes). A word processing application, for instance, can interact with a spelling checker, a thesaurus application, a web browser, a remote file system, etc. The very essence of modern computer systems is the way in which they (and thereby the software applications that they run) are interconnected: locally on LANs (local area networks) and globally through the world-wide internet.

There is, however, a fundamental difficulty in testing the software for concurrent systems of processes. A sequential process normally exhibits deterministic behavior, which means that there is a pre-determined relation between the inputs provided and the outputs generated for these inputs. This makes it relatively easy to setup a test and to evaluate its result. This is quite different for a system of concurrent processes. The relative speeds of execution of concurrently executing processes is almost always uncontrollable by and unobservable to the system tester, yet it can determine all aspects of the behavior of the system, including the outputs that are generated for given inputs. In a telephone system, for instance, the behavior of the response of a switch (a hardware device controlled by many concurrently executing software processes) to any given subscriber action can depend on subtle timings of interactions with both locally and remotely executing processes. These interactions are unavoidable, and essential to providing the required functionality of the switch, but they make comprehensive system testing an extremely difficult task.

Logic model checking techniques are increasingly employed to address the testing problem for concurrent software applications. (See for instance, Gerard J. Holzmann, ‘The model checker Spin’, IEEE Trans. On Software Engineering, Vol. 23, No. 5, May 1997, pp. 279-295.) Traditionally, when these techniques are used, an expert in model checking techniques manually constructs a verification model of the application under study, guided by the designers and programmers of the application for the details of its working. The model can then be checked mechanically to establish its correctness properties, using a model checker. The manual construction of a verification model, however, has several known drawbacks. It can be time-consuming (taking weeks or months to complete); and it requires considerable expertise (typically requiring a PhD. in logic or computer science, with specialization on logic model checking techniques); and it still remains subject to human error, leaving the results of a system test in doubt.

### SUMMARY OF INVENTION

In the method according to the principles of the invention, verification models can be extracted automatically from a given body of program source code, guided by user-defined rules. The extraction process takes no substantial time (in the order of seconds for large programs). The generated model can be checked with thoroughness with standard logic model checking techniques. By automating the construction of the verification model, it becomes possible to track a body of evolving source code for a concurrent systems application with a thorough test system based on model checking, if necessary performing frequent (such as daily or even hourly) verifications.

To generate the verification model, source code parsing techniques are used to build a control flow graph for procedural elements of the source code program. The control flow graph is expressed in alternate specification languages (target languages), including the one that is used by the logic model checking tool SPIN. The basic statements from the source code can be adjusted to be expressible in the target language. In some cases they can be included as is (if the semantics of the target language allow this), in some cases they can be omitted from the generated model (if the validity of the properties to be checked can be determined to be independent of the statements to be dropped), and in some cases they can be syntactically converted in a format that is compatible with the target language. Model extraction according to the principles of the invention makes these determinations and can generate a syntactically correct model in the target language without user intervention.

To perform the conversion from source to target for the purpose of creating a verification model, the model extraction system traverses a standard parse tree of the program source code, and identifies those nodes in the parse tree that correspond to basic statements and conditional expressions (boolean conditionals), and applies either default or user-defined conversions. The user has the option to override the default translation mapping from source to target language by defining entries into a mapping table (alternately and equivalently referred to in this disclosure as a lookup-table, a conversion-table, conversion rules, an abstraction table, or a set of abstraction rules). Each basic statement (such as an assignment, or a function call) is then looked up in the optional conversion table. If absent, the default conversion is applied; if present, the given conversion is applied. The table can be defined manually by a user, or generated by other tools, for instance based on available property definitions that can limit the scope of a verification. One aspect of the table consists of a list of source code strings, represented in a canonical form (omitting redundant white-space characters, and inserting parentheses to establish unambiguous parsing precedences within expressions), matched with desired conversions. Examples of conversions can be ‘skip’ to represent a null statement in the target language, ‘true’ as a conversion for an arbitrary expression, and ‘hide’ as a conversion for statements that can be omitted from the generated model. As will be appreciated, the conversions detailed above are illustrative in nature and can be changed as a function of user preferences or other programming considerations.

In accordance with further alternative embodiments, certain information can be collected at each selected node in the parse tree, e.g., on a recursive basis, and stored in a plurality of data structures. A so-called data dependency graph (“DG*”) for the source code under evaluation can be constructed as a function of the information so collected. Illustratively, each node in the DG* corresponds to a distinct data object. Further, all marked nodes with translations are traversed and particular ones of such nodes are marked as data objects which have been “defined” at least once in the program under study. Such defined data objects are illustratively marked with “D” in the DG*. In addition, other ones of such data objects which have been used (i.e., its value is used in an expression) at least once in the program are marked illustratively with a “U” in the DG*. Also, any data object that is used in at least one operation as marked “hide” in the conversion table is illustratively marked with an “H” in the DG*. The D/U/H markings of data objects in the above described embodiment can serve to facilitate a determination with the respect to the adequacy of the conversion table, and can be used to affect the default settings for the conversion rules.

Advantageously, extracting verification models from software, e.g., source code, in accordance with the aspects of the invention, as detailed herein, provides for increased thoroughness in the verification/testing of software. Significantly, the extraction of the verification model is independent of the underlying source programming language and its associated programming constructs, and extraction according to the principles of the invention can be used in the verification of a variety of programs written in a variety of programming languages.

### BRIEF DESCRIPTION OF THE DRAWINGS

An understanding of the invention can be had with reference to the drawings, in which:

FIG. 1 is a process flow diagram for an exemplary method of model extraction according to the principles of the invention;

FIG. 2 is another process flow diagram for an exemplary method of model extraction according to the principles of the invention; and

FIG. 3 is an exemplary block diagram of a verification system according to the principles of the invention.

### DETAILED DESCRIPTION

The verification system according to the principles of the invention extracts a verification model from implementation level program source code. The verification model (also called model) is defined in such a way that it is necessarily finite state. The set of all possible executions for a finite state model defines a finite, directed and possibly cyclic graph. A set of requirements that the system has to satisfy can be defined independently, in a range of ways, e.g., as formulae expressed in temporal logic, as test automata, or with the help of visual property editing tools. Logical model checking is implemented on the extracted verification model to verify that the system satisfies the stated properties. If a failure to satisfy a required property is detected, the model checking tool generates an example execution of the system that demonstrates this fact. The invention described here can optionally insert print statements into the extracted model in such a manner that the sample execution when reproduced in the model will print out a source trace of the execution, using the source text statements from the original program source code.

(A) Verification Model Extraction

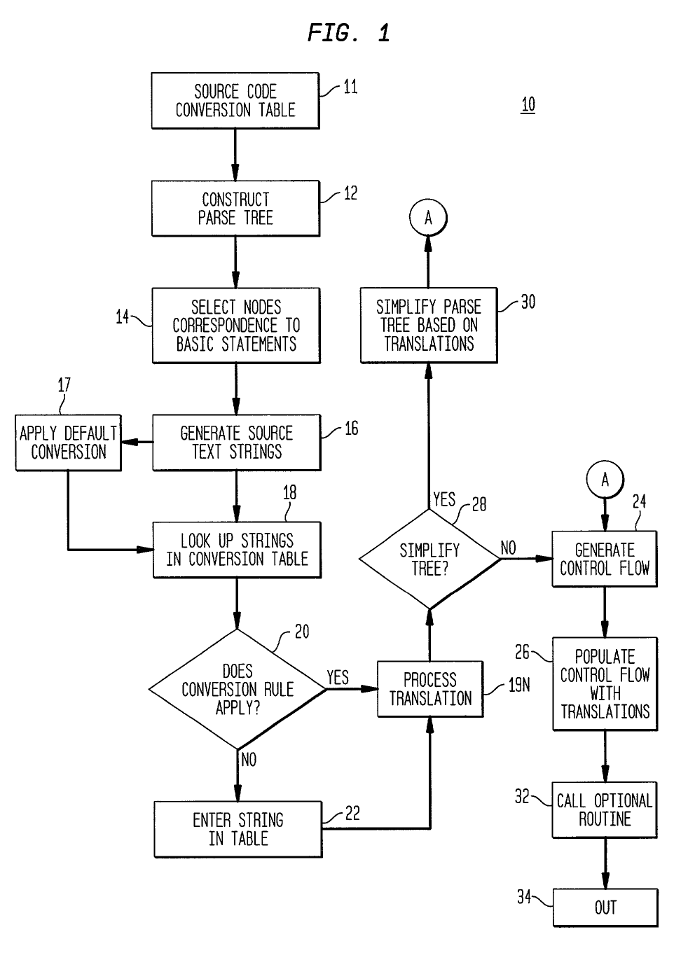

FIG. 1 illustrates a process flow diagram 10 for model extraction according to the principles of the invention. The inputs 11 to the process flow consists of two parts. A first, required, input is the source text of the program that is the subject of the model extraction. A second, optional, input is a lookup table, or set of conversion rules, that can be used to selectively override default conversion rules from the model extraction tool. As will be explained in more detail below, a conversion look-up table acts as a user-defined abstraction filter for reducing selected fragments of the source code program to its relevant functions. Source code conversions are checked against the table for possible presence of explicit conversion rules into the target modelling language. The relevance of the operations to the properties to be verified (determined by independent means) can, for instance, determine which operations need to be represented literally (i.e., with an equivalent representation in the language of the model checker), which operations can be partially abstracted, and which operations can be omitted. The resulting conversions are used to populate a control flow skeleton, or control flow, for the target model, providing a verification model for the properties of interest.

Verification model extraction according to the principles of the invention accepts the source code as an input 11 and, in a first process step 12, a parse tree is constructed from the source code. The source code contains sufficient information to reproduce a valid source program from the parse tree. Construction of a parse tree from source code can be implemented with the known compiler front-end routine cTREE (also known as cTOOL), written by Shaun Filisakowski and distributed under copyright without limitations on non-commercial use. The parsing routine cTREE is also available for download from the World Wide Web. It should be apparent that the precise type of parser used to construct the parse tree is not important, and other standard methods for constructing the parse tree and control-flow graph can be used without departing from the principles of the invention.

Once the parse tree (equivalently the control-flow graph) is constructed, the parse tree is traversed, and nodes that correspond to the basic statements of the source language are selected, as indicated at step 14. Illustratively, basic statements of the source language include declarations, assignments, function calls, return statements, boolean conditions and the like. From the selected nodes, canonical text strings that can later serve as the “inputs” to the conversion table are generated. Additionally, the selected nodes form the leaves of the control flow skeleton that can be reproduced in the target language for the verification model.

For each selected node in the parse tree, a source text string is generated from the information that is available at that node in the parse tree, as at step 16. The selected nodes, as previously stated, correspond to a basic statement in the source code. The statement will generally include references to data objects for which existing values may be used or new values may be defined (e.g., in variable assignments). The selected node and related information contains the information necessary to generate the source text string (as cTREE provides a tree from which the a valid source program can be generated). The precise method of source string preparation may vary without departing from the principles of the invention, and the precise source code language is not critical to the process.

Each source string can be processed, generating a default conversion for the statement, as at 17. The strings can be looked up in the optional conversion table in process step 18. In a decision step 20, it is determined whether the string is in the table. If the string is in the conversion table, the conversion there specified is generated for use in the target model, as at step 19. If the string is not in the conversion table, the default conversion for the string can optionally entered into the table so that it may be found there on subsequent searches of the table, as at step 22. The flow then continues at step 19, where the string is translated according to default conversions or according to the conversion table. In other words, the default conversion holds true if there is no conversion table entry. In this manner, each source text string is translated into the target language, such as the language of a logical model checker.

The conversion table can act as a user-defined abstraction filter for the source text strings. When applied to the source code, it can determine which operations are relevant to the properties to be verified and which statement can be omitted or represented in simplified form. Irrelevant operations can, for instance, be mapped to the nul operation of the model checker. Source strings that are directly relevant to the property to be verified are generally preserved in the model, with only the minimum requisite syntax adjustments. A string that is entirely outside the scope of the verification is advantageously translated to the nul statement, and is thereby stripped from the model. For a partially relevant string, the conversion table can define a mapping function that preserves only the relevant part and suppresses the rest. Additional information on conversion tables can be found in Holzmann, G. J., and Smith M. H., A Practical Method for the Verification of Event-driven Systems, Proc. Int. Conf. on Software Engineering, ICSE99, Los Angeles, pp. 597-608, May 1999.

In one embodiment, there are five pre-defined user-definable conversions for strings entered into the conversion table: keep, hide, true, false, skip, and print. These predefined options do not in any way restrict or prevent the use of other possible conversions, defining arbitrary replacement texts for selected strings. The use of the keyword keep defines that the original statement is preserved as is in target language. The keyword hide omits a translation of the string from the model. The keyword skip maps the source string to the nul statement in the target language. A print translation causes the original statement to print in a verification run.

True and false also can be defined as default translations for boolean conditionals from the source program. For each encountered condition in the parse tree, the model extractor always generates both the original condition and its logical negation for explicit representation in the verification model. Both versions are looked up in the conversion table. This permits the extractor to instrument the verification model in such a way that both the truth and falsity of a condition will be considered in the check performed by the model checker (independent of the actual truth value of the condition), or to preserve the truth value of the condition as defined, or to force the evaluation of the condition firmly to either true or false. By assigning true and false respectively to a condition and the negation of a condition, or false and true (or even true and true for the broadest type of check), the abstracted model can be forced to assume either the truth or the untruth of the condition. The conversion table can contain other generic rules that can be applied to each source string or to its target, to obtain a more general type of control over abstractions.

Optionally, the control flow graph for the target model that is constructed in the manner described above can be simplified prior to generation of the final verification model. In a decision step 28, it is determined whether the parse tree will be simplified. If the simplification is selected, the parse tree is simplified by recursively removing nodes corresponding to nul statements, by removing the successors of false nodes, and by skipping true nodes under certain instances. For example:

1.

::if

::true

:: true

fi;X

can be rewritten X.

2.

if

::true->X

:: true->X

fi

can be rewritten X.

3.

if

false−>X

::false−>Y

fi; Z

can be rewritten “false.”

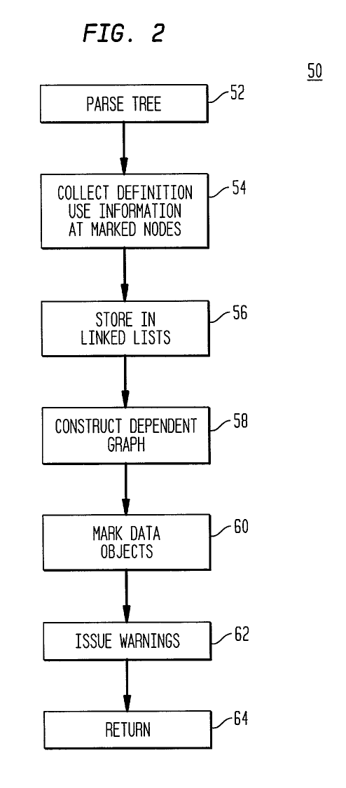

The verification model is generated, in a process step 26, from the control flow graph that is populated with the conversions for the basic statements and conditions, as at step 24. Optionally, a routine may be called, as at 32, to provide the user information about the completeness of the conversion table, as will be explained with reference to FIG. 2. The populated control flow, the verification model, is output in an output step 34. The original source text statements can be embedded in the model, either as comments or inside print statements. In one embodiment, the original statements are embedded in print statements in such a way that if the executions defined by the verification model are simulated by the model checker with the print statements enabled, the printouts will generate a source level execution trace through the original program.

As previously indicated, conditional choices can be constrained such that the model checker treats the possibility of the condition being true or false as equally likely. This is achieved by making use of non-deterministic control structures that are commonly used in model checking languages. Advantageously, this capability also provides for the option to remove all references and uses of irrelevant data objects (data objects that can be determined by independent means to have no bearing on the properties of interest) by non-deterministic choices. The use of non-determinism is a standard technique that can be used to generalize the scope and checking power of a verification model in model checking applications. The non-determinism tells the model checker that all possible outcomes of a choice should be considered equally possible, not just one specifically computed choice.

The optional routine 50 shown in FIG. 2 provides information about the completeness of the conversion table. Definition and use information (information related to the use of the data object in an expression) for each data object is collected at each marked node in the tree, recursively, as at 54. The information is stored at the marked node in three linked lists with pointers to the symbol table for data, as at 56. The three linked lists are for data objects that are used, data objects that are defined, and data objects that are accessed in a manner that cannot easily be determined. For example, access to data via pointers is considered to be data that is accessed in a manner that cannot easily be determined. A data dependency graph based on the definition and use information is constructed. Nodes in a first graph, DG, correspond to distinct data objects. For example, in DG there is a directed edge from node X to node Y if data object Y is used at least once in a definition of data object X. The transitive closure for the dependency relation is computed for DG, and additional edges are added to DG in accordance with the computation. A copy of the data graph is made and given a new name, such as DG*.

The data objects in DG* are marked, as at 60. The marked nodes with translations other than “hide” or “print” have their corresponding data objects marked as follows. Data objects in the definition list are marked with a D, and data objects in the use list are marked with a U in DG*. For nodes with a translation of “hide” or “print”, the corresponding data objects from the definition list are marked with an H in DG*. The markings of data objects in DG* are checked and a warning, as at 62, is issued for every data object that does not have a D or H mark. The warning need not be defined. For every data object that has neither a U nor an H mark, the warning “not used” is provided, as at 62. From these warnings, a user can update or change definitions in the conversion table. Process is then returned to the main routine, as at 64.

The verification method according to the principles of the invention can be used for systems that interact with outside entities in its environment. These entities can be concurrently executing application processes, remote servers, human users, and the like. For entities that interact with the system, an abstract model that captures the essence of the behavior of the outside entity can advantageously be included in the verification model. Because the objective is to verify the behavior of a specific system—rather than the behavior of the remote entities—it is sufficient to model remote entities with a conservative estimate of their possible behaviors; i.e., it is desirable to verify behavior of the system despite the presence of possibly ill-behaved remote entities. Therefore, it is sufficient to model remote entities as generic test-drivers with non-deterministic behavior; i.e., the remote entities select from possible behavior non-deterministically. The non-deterministic selections can be generated with simple software demons. Abstractions based upon non-determinism remove complexity by removing extraneous detail and broaden the scope of the verification by representing one of the classes of possible behavior, instead of selected instances of specific behavior.

(B) Properties

The input into the model checker also includes the properties that the model will be verified against. The particular way in which correctness properties are defined, stored, and used by the model checker for the verification model that is generated by the method disclosed here is outside the scope of this invention. Standard methods to do so include the use the well-known logics known as linear temporal logic (LTL). An positive statement of a correctness requirement expressed as an LTL formula can be negated to formalize all possible violations of the requirement in a systems execution. The negated formula can be translated mechanically into an automaton, which can then used in the model checking process in a standard manner.

(C) Model Checker

Logical model checking can performed using the SPIN model checker. SPIN verification models can define the behavior of systems of asynchronous processes that interact by synchronous or asynchronous message passing, or by shared access to global data. SPIN converts the input specification into a product of automata. The global behavior defined by this product can be checked efficiently for a wide range of correctness properties using an automata theoretic model checking procedure. More information on the automate-theoretic approach to formal verification can be found in: Gerard J. Holzmann, ‘The model checker Spin’, IEEE Trans. On Software Engineering, Vol. 23, No. 5, May 1997, pp. 279-295, and in: Vardi and Wolper, An Automata-theoretic Approach to Automatic Program Verification, Proc. Symp. on Logic in Computer Science, pp. 322-331, Cambridge, June 1986.

SPIN searches the intersection product of the language defined by the system of concurrent processes and the language implicitly defined by the requirement to be proven. The model checking procedure is defined in such a way that if the language intersection product can be proven to be empty, no violation of the requirement is possible. If the intersection product, however, is not empty, it directly defines at least one system execution that demonstrates a potential violation of the requirement by the system. In this case SPIN will generate the execution sequence as proof that the requirement can be violated. As explained, this execution sequence can be reproduced as an execution trace in the original source code of the application by the way in which the model is annotated by the model extractor.

(D) Exemplary Systems

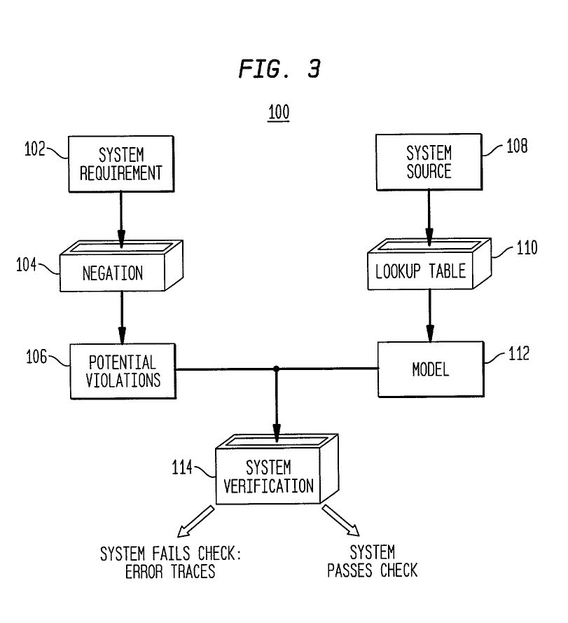

A block diagram for an exemplary system 100 is shown in FIG. 3. The system verification engine 114 implements model checking using, for example, the SPIN model checker described above. The system source code 108 is an input to the abstraction filter (i.e., lookup table) 110, which produces the verification model 112 according to the principles of the invention. The processes described with reference to FIGS. 1 and 2 are exemplary processes for providing the verification model 112. The system requirements or properties are another input to the system, and can be described independently by conventional means as described earlier. The negation of the system requirement is taken 104 to provide a formalization of all violating executions that can potentially exist 106. These potential violations 106 are checked against the model 112 in the verification engine 114.

(E) Exemplary Feature Verifications

In accordance with an embodiment of the invention, feature verification is achieved in the context of call processing environments as discussed in greater detail in Appendix A hereto. In accordance with a further embodiment of the invention, a model extraction is performed as a function of ANSI C program code, e.g., a communications protocol implementation, i.e., an alternating bit protocol, as more fully set forth in Appendix B. Of course, the embodiments detailed herein are illustrative and not exhaustive. That is, the aspects of the invention can be applied to any source programming language and extract a verification model in the specification language of any suitable model checking system. In context of software verification systems the aspects of the invention are universally applied to any given source language, e.g. C, C++ or Java, and any given target language, e.g., the Spin model checker.

What is claimed is:

1. A method for extracting a verification model from program source code comprising the steps of:
generating a parse tree defining a control flow from the source code;
identifying source code elements;
from the parse tree, generating source strings for selected ones of the source code elements;
defining corresponding default conversions for translating the source strings into a target language of a model checker; and
generating a verification model in the target language, wherein the verification model conforms to the control flow and to the corresponding default conversions for the selected ones of the source code elements.

2. The method of claim 1 comprising the further steps of:
optionally searching a conversion table for an entry associated with at least one of the source strings, the entry including a translation for the at least one of the source strings; and
substituting the translation for the corresponding default conversion for the at least one of the source strings, wherein the verification model further conforms to the translation.

3. The method of claim 1 wherein the source code elements include basic statements and boolean conditionals.

4. The method of claim 1 wherein the generating of source text strings includes the further step of expressing the source text strings in a canonical form.

5. The method of claim 1 wherein specifics of the corresponding default conversions can depend on a usage of the selected ones of the source code elements.

6. The method of claim 2 wherein the conversion table further includes samples of source strings.

7. The method of claim 2 wherein the conversion table further includes classes of source strings.

8. The method of claim 6 wherein the searching of the conversion table includes the step of pattern matching the at least one of the source strings to the samples of source strings.

9. The method of claim 7 wherein the searching of the conversion table includes the step of pattern matching the at least one of the source strings to the classes of source strings.

10. The method of claim 1 wherein the corresponding default conversions causes the translating of the source strings to respective equivalent statements in the target language when the selected ones of the source code elements are fully relevant to a property to be tested, the translating of the source strings to nul statements in the target language when the selected ones of the source code elements are irrelevant to the property to be tested, and the translating of the source strings to preservation statements in the target language when the selected ones of the source code elements are partially relevant to the property to be tested, preservation statements being statements that preserve a relevant part of the source strings and that suppress an irrelevant part of the source strings.

11. The method of claim 2 wherein the generating a verification model step includes the further step of translating ones of the source strings to a non-deterministic choice of possible outcomes.

12. The method of claim 2 wherein the generating a verification model step includes the step of populating the control flow with the translated source strings.

13. The method of claim 1 wherein the default conversion includes a keep, the keep causing the generating of a verification model step to provide an equivalent statement in the target language.

14. The method of claim 1 wherein the default conversion comprises a hide, the hide causing the generating of a verification model step to provide a nul statement in the target language.

15. The method of claim 1 wherein the default conversion comprises a print, the print causing the generating of a verification model step to embed the respective source strings in a print statement in the target language.

16. The method of claim 2 comprising the further step of simplifying the parse tree according to the translated source strings.

17. The method of claim 16 wherein the simplifying step includes the steps of:
removing nodes corresponding to nul statements;
removing nodes successive to false nodes; and
skipping selected nodess mapped to true.

18. The method of claim 3 comprising the farther steps of:
collecting certain data object information for nodes in the parse tree corresponding to basic statements in the source code, the certain data object information including definition information and use information;
constructing a data dependency graph for the source code based upon the collected data object information, the data dependency graph having data dependency graph nodes corresponding to a data object, the data dependency graph having directed edges from first data dependency graph nodes to successive data dependency graph nodes if the successive data dependency graph nodes are used at least once in a definition of the first data dependency graph nodes;
determining a transitive closure for the data dependency graph dependency relation;
adding edges to the data dependency graph according to the transitive closure, the adding step providing a second data dependency graph;
for nodes corresponding to basic statements in the source code having translations other than hide or print, marking second data dependency graph data objects with identifiers corresponding to the definition information and the use information;
for nodes corresponding to basic statements in the source code having a hide translation; marking second data dependency graph data objects with a hide identifier; and
checking the second data dependency graph data objects for identifiers and the hide identifier.

19. A method for verifying that a software based system satisfies certain properties, the software based system having a source code, comprising the steps of: extracting a finite state model from the source code, the extracting step including the steps of:
abstracting the source code statements based upon relevancies between the certain properties and the source code statements; and
expressing the finite state model in an input language for a model checker; and
checking the finite state model for the certain properties in the model checker.

20. A system for verifying that a system satisfies certain properties, the system having a source code, comprising:
a model extractor operable to extract a finite state model from the source code, the model extractor implementing default conversions for translating selected source code elements and including:
a table of translations for translating other selected source code elements based upon defined abstractions, and
a translator responsive to the translations of the selected source code elements and the other selected source code elements for expressing the finite state model in an input language for a model checker, and
a model checker responsive to the certain properties and the finite state model for checking the finite state model for the certain properties.

21. The system of claim 20 wherein the model extractor further includes a parser for constructing a parse tree from the source code, wherein the translator translates source strings generated from the parse tree.

22. The system of claim 21 wherein the model extractor further operates to provide a control flow from the parse tree and to populate the control flow with translated source strings.

23. A method for extracting a verification model from source code having a control flow, comprising the steps of:
generating selected source strings from the source code;
translating ones of the selected source strings to corresponding target language statements according to default conversions;
optionally searching a conversion table for entries associated with the selected source strings, the conversion table including a plurality of translations associated with various ones of the source strings;
translating other ones of the selected source strings to corresponding target language statements according to the entries; and
populating the control flow with the target language statements.
